(19) United States
(12) Patent Application Publication
(10) Pub. No.: US 2012/0322694 A1
(43) Pub. Date: Dec. 20, 2012

(54) Electrically Conductive Oil-Base Fluids for Oil and Gas Applications

(75) Inventors: Othon Rego Monteiro, Houston, TX (US); Jonathan J. Brege, Spring, TX (US); Lirio Quintero, Houston, TX (US); Soma Chakroborty, Houston, TX (US); Ashley D. Leonard, Houston, TX (US); Chad F. Christian, Houston, TX (US)

(73) Assignee: BAKER HUGHES INCORPORATED, Houston, TX (US)

(21) Appl. No.: 13/545,706

(22) Filed: Jul. 10, 2012

Related U.S. Application Data
(63) Continuation-in-part of application No. 13/424,549, filed on Mar. 20, 2012.
Application No. 13/424,549 is a continuation-in-part of application No. 13/166,448, filed on Jun. 22, 2011.
(60) Provisional application No. 61/508,199, filed on Jul. 15, 2011.
(60) Provisional application No. 61/466,259, filed on Mar. 22, 2011.
(60) Provisional application No. 61/359,111, filed on Jun. 28, 2010.

(51) Int. Cl. C09K 8/00; C09K 8/84; C09K 8/60; C09K 8/32; C09K 8/06; B82Y 30/00

(52) U.S. Cl. 507/105; 507/135; 507/103; 507/110; 507/136; 507/142; 507/131; 507/117; 507/259; 507/260; 507/267; 507/209; 507/261; 507/244; 507/203; 507/205; 507/268; 507/266; 507/219; 507/129; 507/248; 977/773; 977/775; 977/734

(57) ABSTRACT

A base fluid may contain nanoparticles where the base fluid may include a non-aqueous fluid, an aqueous fluid, and combinations thereof. The fluid may have a resistivity range of from about 0.02 ohm-m to about 1,000,000 ohm-m. The non-aqueous fluid may be a brine-in-oil emulsion, or a water-in-oil emulsion; and the aqueous fluid may be an oil-in-water emulsion, or an oil-in-brine emulsion; and combinations thereof. The addition of nanoparticles to the base fluid may improve or increase the electrical conductivity and other electrical properties of the fluid. The fluid may be a drilling fluid, a completion fluid, a production fluid, and/or a stimulation fluid.

### CROSS-REFERENCE TO RELATED APPLICATIONS

This application claims the benefit of U.S. Provisional Application Ser. No. 61/508,199 filed Jul. 15, 2011, and is Continuation-in-Part of U.S. application Ser. No. 13/424,549, filed Mar. 20, 2012 and claims the benefit of U.S. Provisional Application Ser. No. 61/466,259 filed Mar. 22, 2011, and is a Continuation-in-Part of U.S. application Ser. No. 13/166,448 filed Jun. 22, 2011 and claims the benefit of U.S. Provisional Application Ser. No. 61/359,111 filed Jun. 28, 2010, all are incorporated by reference herein in their entirety.

### TECHNICAL FIELD

The present invention relates to a fluid composition and a method for improving the electrical conductivity of a base fluid selected from the group consisting of a non-aqueous fluid, an aqueous fluid, and combinations thereof by adding nanoparticles to the base fluid, so the resistivity of the fluid composition may be from about 0.02 ohm-m to about 1,000,000 ohm-m.

### BACKGROUND

Fluids used in the drilling, completion, production, and remediation of subterranean oil and gas wells are known. It will be appreciated that within the context herein, the term “fluid” also encompasses “drilling fluids”, “completion fluids”, “workover fluids”, “servicing fluids”, “production fluids”, and “remediation fluids”.

Drilling fluids are typically classified according to their base fluid. In water-based fluids, solid particles are suspended in a continuous phase consisting of water or brine. Oil can be emulsified in the water which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, or a brine-in-non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally-occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

For some applications, in particular for the use of some wellbore imaging tools, it is important to reduce the electrical resistivity (which is equivalent to increase the electrical conductivity) of the oil-based fluid. It would be desirable if fluid compositions and methods could be devised to increase the electrical conductivity of the oil-based or non-aqueous-liquid-based drilling, completion, production, and remediation fluids and thereby allow for better utilization of resistivity logging tools.

There are a variety of functions and characteristics that are expected of completion fluids. The completion fluid may be placed in a well to facilitate final operations prior to initiation of production. Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof.

Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Water-thickening polymers serve to increase the viscosity of the brines and thus retard the migration of the brines into the formation and lift drilled solids from the well-bore. A regular drilling fluid is usually not compatible for completion operations because of its solid content, pH, and ionic composition.

Completion fluids also help place certain completion-related equipment, such as gravel packs, without damaging the producing subterranean formation zones. Conventional drilling fluids are rarely suitable for completion operations due to their solids content, pH, and ionic composition. The completion fluid should be chemically compatible with the subterranean reservoir formation and its fluids. Modifying the electrical conductivity and resistivity of completion fluids may allow the use of resistivity logging tools for facilitating final operations.

Servicing fluids, such as remediation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include wireline tools, packers, perforating guns, flow-rate sensors, electric logging sondes, etc.

It would be desirable if the aforementioned fluid compositions and methods for using such fluids could be tailored to improve the electrical conductivity of drilling fluids, completion fluids, and servicing fluids, and thereby enhance the performance of resistivity logging tools in one example.

### SUMMARY

There is provided, in one non-limiting form, a fluid that may include a base fluid selected from the group consisting of an oil-based fluid, a water-based fluid, and combinations thereof. The fluid may also include nanoparticles selected from the group consisting of graphene nanoparticles, graphene platelets, graphene oxide, electrically-conductive nanotubes, electrically-conductive nanorods, electrically-conductive nanoplatelets, and combinations thereof. In a non-limiting embodiment, the nanoparticles may be selected from the group consisting of functionalized nanoparticles, chemically-modified nanoparticles, covalently-modified nanoparticles, physically-modified nanoparticles, electrostatically modified and combinations thereof. In a further non-limiting embodiment, the fluid composition may include a surfactant in an amount effective to suspend the nanoparticles in the base fluid. The fluid may have a resistivity range of from about 0.02 ohm-m to about 1,000,000 ohm-m.

In another non-limiting form, a method for improving the electrical conductivity of a fluid is provided. The method may include adding nanoparticles to a base fluid where the nanoparticles are selected from the group consisting of graphene nanoparticles, graphene platelets, electrically-conductive nanotubes, electrically-conductive nanorods, electrically-conductive nanoplatelets, graphene oxide, fullerenes, nano-diamonds, nanoribbon, carbon black, and combinations thereof. In a non-limiting embodiment, the nanoparticles may be chemically-modified, covalently modified, physically modified, and combinations thereof. The base fluid may be selected from the group consisting of an oil-based fluid, a water-based fluid, and combinations thereof. In another non-limiting embodiment, the method may include adding a surfactant in an amount effective to suspend the nanoparticles in the base fluid. The nanoparticles may be dispersed in the base fluid such that the fluid has a resistivity range of from about 0.02 ohm-m to about 1,000,000 ohm-m.

### BRIEF DESCRIPTION OF THE DRAWINGS

FIG. 1 is a graph illustrating the measured resistivity of several samples having the same mineral oil-based fluid where three different types of nanoparticle blends were added thereto in varying amounts; and

FIG. 2 is a graph illustrating the measured resistivity of three different types of mineral oil-based fluids having the same nanoparticle blend added thereto in varying amounts.

### DETAILED DESCRIPTION

It has been discovered that the electrical conductivity of a base fluid may be modified by adding nanoparticles to the base fluid such that the use of a downhole tool, such as a resistivity logging tool in a non-limiting example, in non-aqueous fluids may be permitted. These tools are typically only used in aqueous fluids, such as water-based fluids in a non-limiting example, because resistivity logging tools require the fluid in the wellbore to be electrically conductive. The dispersion of electrically conductive nano-materials, into at least one phase of the non-aqueous fluid, such as the continuous phase in a non-limiting embodiment, the continuous phase of the non-aqueous fluid will alter the electrical conductivity of the non-aqueous fluid. The final electrical conductivity of the composite fluid is determined by the content and the inherent properties of the dispersed phase content, which may be tailored to achieve the desired values of electrical conductivity. The final resistivity of the composite fluid, once the nanoparticles have been added, may then fall within the range of 0.02 ohm-m and 1,000,000 ohm-m, which is the desired range for the resistivity of a fluid that may be used for resistivity imaging. Achieving this range of resistivity within a non-aqueous fluid represents a decrease of 6-9 orders of magnitude as compared with the resistivity of typical non-aqueous fluids absent the nanoparticles.

The nanoparticles to be added to the base fluid may be graphene nanoparticles, graphene platelets, graphene oxide, electrically-conductive nanotubes, electrically-conductive nanorods, electrically-conductive nanoplatelets, and combinations thereof. In a non-limiting embodiment, nanotubes may be added to the fluid in addition to or as the nanoparticles. The electrically-conductive nanotubes, electrically-conductive nanorods, and/or the electrically-conductive nanoplatelets may be metallic, ceramic, or combinations thereof in an alternative embodiment. In one non-limiting embodiment the nanotubes are carbon nanotubes. The base fluid may be a non-aqueous fluid, an aqueous fluid, and combinations thereof. The non-aqueous fluid may be a brine-in-oil emulsion, or a water-in-oil emulsion, and combinations thereof. In a non-limiting example, the base fluid may be selected from the group consisting of a completion fluid, a production fluid, a servicing fluid, or a stimulation fluid.

The amount of nanoparticles added to the fluid may range from about 0.0001 wt % to about 15 wt % to modify the electrical conductivity of the fluid. In a non-limiting embodiment, the nanoparticles may be added in an amount ranging from about 0.001 wt % to about 5 wt %, alternatively from about 0.01 wt % to about 1 wt %. The nanoparticles may be dispersed in the base fluid so that the fluid may have a resistivity range of from about 0.02 ohm-m to about 1,000,000 ohm-m in one non-limiting embodiment. In an alternative embodiment, the resistivity range may be from about 0.2 ohm-m to about 10,000 ohm-m, or from about 2 ohm-m to about 1,000 ohm-m. The modified electrical conductivity of the fluid may improve the performance of a downhole tool as compared to an otherwise identical fluid absent the nanoparticles.

The nanoparticles may be chemically-modified nanoparticles, covalently-modified nanoparticles, physically modified nanoparticles, functionalized nanoparticles, and combinations thereof. The modification and/or functionalization of the nanoparticles may improve the dispersibility of the nanoparticles in a non-aqueous fluid by stabilizing the nanoparticles in suspension, which avoids undesirable flocculation as compared with otherwise identical nanoparticles that have not been modified or functionalized. In one non-limiting embodiment of the invention, it is desirable that the conductivity properties of the fluid be uniform, which requires the distribution of the nanoparticles to be uniform. If the nanoparticles flocculate, drop out, or precipitate, the modified or improved conductivity or resistivity property of the fluid may change.

Graphene is an allotrope of carbon, whose structure is a planar sheet of sp2-bonded carbon atoms that are densely packed in a 2-dimensional honeycomb crystal lattice. The term “graphene” is used herein to include particles that may contain more than one atomic plane, but still with a layered morphology, i.e. one in which one of the dimensions is significantly smaller than the other two, and also may include any graphene that has been chemically modified, physically modified, covalently modified, and/or functionally modified. Although there is no exact maximum number of layers in graphene, a typical maximum number of monoatomic-thick layers in the graphene nanoparticles here is between fifty (50) and one hundred (100). The structure of graphene is hexagonal, and graphene is often referred as a 2-dimensional (2-D) material. The 2-D morphology of the graphene nanoparticles is of utmost importance when carrying out the useful applications relevant to the graphene nanoparticles. The applications of graphite, the 3-D version of graphene, are not equivalent to the 2-D applications of graphene. The graphene may have at least one graphene sheet, and each graphene platelet may have a thickness no greater than 100 nm.

Graphene is in the form of one-atomic layer thick or multi-atomic layer thick platelets. Graphene platelets may have in-plane dimensions ranging from sub-micrometer to about 100 s micrometers. These types of platelets share many of the same characteristics as carbon nanotubes. The platelet chemical structure makes it easier to functionalize or modify the platelet for enhanced dispersion in polymers. Graphene platelets provide electrical conductivity that is similar to copper, but the density of the platelets is about four times less than that of copper, which allows for lighter materials. The graphene platelets are also fifty (50) times stronger than steel with a surface area that is twice that of carbon nanotubes.

Carbon nanotubes are defined herein as allotropes of carbon consisting of one or several single-atomic layers of graphene rolled into a cylindrical nanostructure. Nanotubes may be single-walled, double-walled or multi-walled.

Electrical conductivity properties of graphene have been measured and compare well with those of carbon nanotubes. The 2-D morphology, however, provides significant benefits when dispersed in complex fluids, such as multi-phasic fluids or emulsions. Unique to this application is the engineering of the graphene dispersion within the non-conducting phase of the fluid, to achieve the desired properties.

In the present context, the nanoparticles may have at least one dimension less than 50 nm, although other dimensions may be larger than this. In a non-limiting embodiment, the nanoparticles may have one dimension less than 30 nm, or alternatively 10 nm. In one non-limiting instance, the smallest dimension of the nanoparticles may be less than 5 nm, but the length of the nanoparticles may be much longer than 100 nm, for instance 25000 nm or more. Such nanoparticles would be within the scope of the fluids herein.

Nanoparticles typically have at least one of dimension less than 100 nm (one hundred nanometers). While materials on a micron scale have properties similar to the larger materials from which they are derived, assuming homogeneous composition, the same is not true of nanoparticles. An immediate example is the very large interfacial or surface area per volume for nanoparticles. The consequence of this phenomenon is a very large potential for interaction with other matter, as a function of volume. For nanoparticles, the surface area may be up to 1800 m²/g. Additionally, because of the very large surface area to volume present with graphene, it is expected that in most, if not all cases, much less proportion of graphene nanoparticles need be employed relative to micron-sized additives conventionally used to achieve or accomplish a similar effect.

Nevertheless, it should be understood that surface-modified nanoparticles may find utility in the compositions and methods herein. “Surface-modification” is defined here as the process of altering or modifying the surface properties of a particle by any means, including but not limited to physical, chemical, electrochemical or mechanical means, and with the intent to provide a unique desirable property or combination of properties to the surface of the nanoparticle, which differs from the properties of the surface of the unprocessed nanoparticle.

The nanoparticles may be functionally modified to introduce chemical functional groups thereon, for instance by reacting the graphene nanoparticles with a peroxide such as diacyl peroxide to add acyl groups which are in turn reacted with diamines to give amine functionality, which may be further reacted. Functionalized nanoparticles are defined herein as those which have had their edges or surfaces modified to contain at least one functional group including, but not necessarily limited to, sulfonate, sulfate, sulfosuccinate, thiosulfate, succinate, carboxylate, hydroxyl, glucoside, ethoxylate, propoxylate, phosphate, ethoxylate, ether, amines, amides, ethoxylate-propoxylate, an alkyl, an alkenyl, a phenyl, a benzyl, a perfluoro, thiol, an ester, an epoxy, a keto, a lactone, a metal, an organo-metallic group, an oligomer, a polymer, or combinations thereof.

Introduction of functional groups by derivatizing the olefinic functionality associated with the nanoparticles may be effected by any of numerous known methods for direct carbon-carbon bond formation to an olefinic bond, or by linking to a functional group derived from an olefin. Exemplary methods of functionalizing may include, but are not limited to, reactions such as oxidation or oxidative cleavage of olefins to form alcohols, diols, or carbonyl groups including aldehydes, ketones, or carboxylic acids; diazotization of olefins proceeding by the Sandmeyer reaction; intercalation/metallization of a nanodiamond by treatment with a reactive metal such as an alkali metal including lithium, sodium, potassium, and the like, to form an anionic intermediate, followed by treatment with a molecule capable of reacting with the metalized nanodiamond such as a carbonyl-containing species (carbon dioxide, carboxylic acids, anhydrides, esters, amides, imides, etc.), an alkyl species having a leaving group such as a halide (Cl, Br, I), a tosylate, a mesylate, or other reactive esters such as alkyl halides, alkyl tosylates, etc.; molecules having benzylic functional groups; use of transmetalated species with boron, zinc, or tin groups which react with e.g., aromatic halides in the presence of catalysts such as palladium, copper, or nickel, which proceed via mechanisms such as that of a Suzuki coupling reaction or the Stille reaction; pericyclic reactions (e.g., 3 or 4+2) or thermocyclic (2+2) cycloadditions of other olefins, dienes, heteroatom substituted olefins, and combinations thereof.

It will be appreciated that the above methods are intended to illustrate the concept of introducing functional groups to a nanoparticle, and should not be considered as limiting to such methods.

Prior to functionalization the nanoparticle may be exfoliated. Exemplary exfoliation methods include, but are not necessarily limited to, those practiced in the art such as fluorination, acid intercalation, acid intercalation followed by thermal shock treatment, and the like. Exfoliation of the graphene provides a graphene having fewer layers than non-exfoliated graphene.

The effective medium theory states that properties of materials or fluids comprising different phases can be estimated from the knowledge of the properties of the individual phases and their volumetric fraction in the mixture. In particular if a conducting particle is dispersed in a dielectric fluid, the electrical conductivity of the dispersion will slowly increase for small additions of nanoparticles. As nanoparticles are continually added to the dispersion, the conductivity of the fluid increases, i.e. there is a strong correlation between increased conductivity and increased concentration of nanoparticles. This concentration is often referred to as the percolation limit.

In the case of thermal conductivity of nanofluids (i.e. dispersion of nanoparticles in fluids), the percolation limit decreases with decreasing the size of the nanoparticles. This dependence of the percolation limit on the concentration of the nanoparticles holds for other fluid properties that depend on inter-particle average distance.

There is also a strong dependence on the shape of the nanoparticles dispersed within the phases for the percolation limit of nano-dispersions. The percolation limit shifts further towards lower concentrations of the dispersed phase if the nanoparticles have characteristic 2-D (platelets) or 1-D (nanotubes or nanorods) morphology. Thus the amount of 2-D or 1-D nanoparticles necessary to achieve a certain change in property is significantly smaller than the amount of 3-D nanoparticles that would be required to accomplish a similar effect.

In one sense, such fluids have made use of nanoparticles for many years, since the clays commonly used in drilling fluids are naturally-occurring, 1 nm thick discs of aluminosilicates. Such nanoparticles exhibit extraordinary rheological properties in water and oil. However, in contrast, the nanoparticles that are the main topic herein are synthetically formed nanoparticles where size, shape and chemical composition are carefully controlled and give a particular property or effect.

The fluids herein, which may include drilling fluids, completion fluids, production fluids, and servicing fluids, except as noted, may contain nanoparticles which beneficially affect the electrical conductivity of the fluids. In some cases, the nanoparticles may change the properties of the fluids in which they reside, based on various stimuli including, but not necessarily limited to, temperature, pressure, rheology, pH, chemical composition, salinity, and the like. This is due to the fact that the nanoparticles can be custom designed on an atomic level to have very specific functional groups, and thus the nanoparticles react to a change in surroundings or conditions in a way that is beneficial. It should be understood that it is expected that nanoparticles may have more than one type of functional group, making them multifunctional. Multifunctional nanoparticles may be useful for simultaneous applications, in a non-limiting example of a fluid, lubricating the bit, increasing the temperature stability of the fluid, stabilizing the shale while drilling and provide low shear rate viscosity. In another non-restrictive embodiment, nanoparticles suitable for stabilizing shale include those having an electric charge that permits them to associate with the shale.

The use of surfactants together with the nanoparticles may form self-assembly structures that may enhance the thermodynamic, physical, and rheological properties of these types of fluids. The use of surfactants is optional. These nanoparticles are dispersed in the base fluid. The base fluid may be a drilling fluid, a completion fluid, a production fluid, or a stimulation fluid. The base fluid may be a non-aqueous fluid or an aqueous fluid, or the base fluid may be a single-phase fluid, or a poly-phase fluid, such as an emulsion of oil-in-water (O/W) or water-in-oil (W/O). The nanoparticles may be used in conventional operations and challenging operations that require stable fluids for high temperature and pressure conditions (HTHP).

Such fluids are expected to find uses in, but are not limited to reservoir operations including reservoir imaging, resistivity logging, drilling fluids, completion fluids, remediation fluids, and reservoir stimulation. It may be helpful in designing new fluids containing engineered nanoparticles to match the amount of the nanoparticles with the proper surfactant/base fluid ratio to achieve the desired dispersion for the particular fluid. Surfactants are generally considered optional, but may be used to improve the quality of the dispersion of the nanoparticles. Such surfactants may be present in the base fluids in amounts from about 0.01 wt % independently to about 15 wt %, alternatively from about 0.01 wt % independently to about 5 wt %, where “independently” as used herein means that any lower threshold may be combined with any upper threshold to define an acceptable alternative range.

Ways of dispersing colloidal-size particles in fluids is known, but how to disperse nanoparticles within the fluids may be a challenge. Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension and an ionic or nonionic polar group. Other suitable surfactants may be dimeric or gemini surfactants, cleavable surfactants, janus surfactants and extended surfactants, also called extended chain surfactants.

It is also anticipated that combinations of certain surfactants and nanoparticles will “self-assemble” into useful structures, similar to the way certain compositions containing surfactants self-assemble into liquid crystals of various different structures and orientations.

Covalent functionalization may include, but is not necessarily limited to, oxidation and subsequent chemical modification of oxidized nanoparticles, fluorination, free radical additions, addition of carbenes, nitrenes and other radicals, arylamine attachment via diazonium chemistry, and the like. Besides covalent functionalization, chemical functionality may be introduced by noncovalent functionalization, electrostatic interactions, π-π interactions and polymer interactions, such as wrapping a nanoparticle with a polymer, direct attachment of reactants to nanoparticles by attacking the sp² bonds, direct attachment to ends of nanoparticles or to the edges of the nanoparticles, and the like. The amount of nanoparticles in the fluid may range from about 0.0001 wt % independently to about 15 wt %, and from about 0.001 wt % independently to about 5 wt % in an alternate non-limiting embodiment.

In one non-restrictive version, the average nanoparticle length for the nanoparticles to improve the electrical conductivity properties may range from about 1 nm independently to about 10,000 nm, alternatively from about 10 nm independently to about 1000 nm. Nanoparticles can conduct electrical charge, so they may improve the conductivity of the fluids. Enhanced electrical conductivity of the fluids may form an electrically conductive filter cake that highly improves real time high resolution logging processes, as compared with an otherwise identical fluid absent the nanoparticles.

Other benefits that may arise from modifying the electrical conductivity of the drilling or completion fluids may include enabling the implementation of measuring tools based on resistivity with superior image resolution, and therefore improving the ability of the driller to improve its efficiency. It may also be conceivable that electric signal will be able to be carried through the drilling fluids across longer distances, such as across widely spaced electrodes in or around the bottom-hole assembly, or even from the bottom of the wellbore to intermediate stations or the surface of the well.

The invention will be further described with respect to the following Examples, which are not meant to limit the invention, but rather to further illustrate the various embodiments.

### Example 1

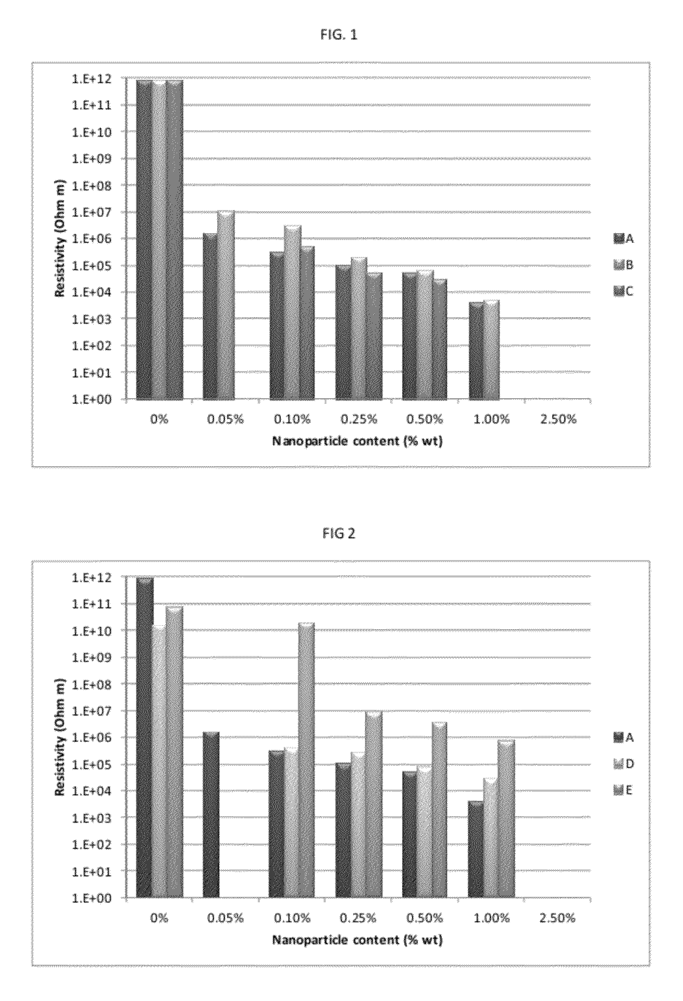

The resistivity was measured of several samples containing the same mineral oil-based fluid, but three different types of nanoparticle blends were added thereto in varying amounts; the results are depicted in FIG. 1. The mineral oil was CLAIRSOL NS™, which is a base oil distributed by Petrochem Carless. Nanoparticle blend ‘A’ included a mixture of graphene platelets and microcrystalline graphite. The graphene platelets had an in-plane dimension of about 5 μm, and the microcrystalline graphite also had a particle size of about 5 μm. Nanoparticle blend ‘B’ included a mixture of graphene and microcrystalline graphite where the microcrystalline graphite had a particle size of about 2 μm. Nanoparticle blend ‘C’ included graphene platelets with an in-plane dimension of about 5 μm; microcrystalline graphite was not part of nanoparticle blend ‘C’. As noted by the graph, the resistivity of each mineral oil-based fluid decreased as the % wt of each nanoparticle blend increased.

### Example 2

The resistivity of a nanoparticle dispersion in three types of mineral oils was measured to determine the effect of the dispersing phase on the resistivity of the nanoparticle dispersion. The nanoparticle dispersion was the same as the nanoparticle blend ‘A’ noted in Example 1, i.e. a mixture of graphene platelets and microcrystalline graphite. The graphene platelets had an in-plane dimension of about 5 μm, and the microcrystalline graphite also had a particle size of about 5 μm. The results of these measurements using the same nanoparticle blend added to three different types of mineral oils are depicted in FIG. 2. The mineral oil used for the nanoparticle dispersion A was CLAIRSOL NS™, which is a base oil distributed by Petrochem Carless. The mineral oil used for nanoparticle dispersion D was ESCAID 100™, which is a de-aromatized mix of hydrocarbons distributed by Exxon Mobil. The mineral oil used for nanoparticle dispersion E was GT-3000, which is an isomerized olefin distributed by Baker Hughes. As noted by the graph, the resistivity of each oil-based fluid decreased as the % wt of each nanoparticle blend increased.

In the foregoing specification, the invention has been described with reference to specific embodiments thereof, and has been suggested as effective in providing effective methods and compositions for improving completion fluids, production fluids, and servicing fluids used in drilling, completing, producing, and remediating subterranean reservoirs and formations. However, it will be evident that various modifications and changes may be made thereto without departing from the broader spirit or scope of the invention as set forth in the appended claims. Accordingly, the specification is to be regarded in an illustrative rather than a restrictive sense. For example, specific combinations of components and/or reaction conditions for forming the nanoparticles, whether modified to have particular shapes or certain functional groups thereon, but not specifically identified or tried in a particular drilling fluid, completion fluid, production fluid, or servicing fluid to improve the properties therein, are anticipated to be within the scope of this invention.

The present invention may suitably comprise, consist or consist essentially of the elements disclosed and may be practiced in the absence of an element not disclosed. For instance, the fluid may consist of or consist essentially of the base fluid and the nanoparticles where the fluid has a resistivity range of from about 0.02 ohm-m to about 1,000,000 ohm-m, as further defined in the claims. Alternatively, the fluid may consist of or consist essentially of the base fluid, the nanoparticles, and a surfactant where the fluid may have a resistivity range of from about 0.02 ohm-m to about 1,000,000 ohm-m, as further defined in the claims. In each of these examples, the fluid may contain conventional additives.

The words “comprising” and “comprises” as used throughout the claims is to be interpreted as meaning “including but not limited to”.

What is claimed is:

1. A fluid having electrically conductive properties comprising:
a base fluid selected from the group consisting of a non-aqueous fluid, an aqueous fluid, and combinations thereof;
nanoparticles selected from the group consisting of graphene nanoparticles, graphene platelets, graphene oxide, electrically conductive nanorods, and electrically conductive nanoplatelets, and combinations thereof; and
wherein the fluid has a resistivity range of from about 0.02 ohm-m to about 1,000,000 ohm-m.

2. The fluid of claim 1, further comprising electrically conductive nanotubes in addition to the nanoparticles.

3. The fluid of claim 1, wherein the nanoparticles are present in the fluid in an amount effective to improve the performance of a downhole tool as compared to an otherwise identical fluid absent the nanoparticles.

4. The fluid of claim 1, wherein the nanoparticles have at least one dimension no greater than about 1000 nm.

5. The fluid of claim 1, wherein the base fluid is selected from the group consisting of a drilling fluid, a completion fluid, a production fluid, a stimulation fluid, and combinations thereof.

6. The fluid of claim 1 wherein the nanoparticles are selected from the group consisting of chemically-modified nanoparticles, covalently-modified nanoparticles, functionalized nanoparticles, exfoliated nanoparticles, physically-modified nanoparticles, electrostatically modified nanoparticles, and combinations thereof; wherein the modification and/or functionalization of the nanoparticles improves their dispersibility in a non-aqueous fluid as compared with otherwise identical nanoparticles that have not been modified or functionalized.

7. The fluid of claim 1 wherein the nanoparticles are functionalized nanoparticles having at least one functional group selected from the group consisting of a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

8. The fluid of claim 1, wherein the nanoparticles are covalently-modified nanoparticles having at least one covalent modification selected from the group consisting of oxidation; free radical additions; addition of carbenes, nitrenes and other radicals; arylamine attachment via diazonium chemistry; and combinations thereof.

9. The fluid of claim 1, wherein the nanoparticle is exfoliated by a method selected from the group consisting of fluorination, acid intercalation, acid intercalation followed by thermal shock treatment, and a combination thereof.

10. The fluid of claim 1 wherein the amount of nanoparticles within the fluid range from about 0.0001 wt % to about 15 wt %.

11. A fluid having electrically conductive properties comprising:
a base fluid selected from the group consisting of a non-aqueous fluid, an aqueous fluid, and combinations thereof;
nanoparticles selected from the group consisting of graphene nanoparticles, graphene platelets, graphene oxide, electrically-conductive nanotubes, electrically-conductive nanorods, electrically-conductive nanoplatelets, and combinations thereof; wherein the nanoparticles are selected from the group consisting of functionalized nanoparticles, chemically-modified nanoparticles, covalently modified nanoparticles, and combinations thereof;
a surfactant in an amount effective to suspend the nanoparticles in the base fluid; and
wherein the fluid has a resistivity range of from about 0.02 ohm-m to about 1,000,000 ohm-m.

12. A method for improving the electrical conductivity of a fluid where the method comprises adding nanoparticles to a base fluid; wherein the nanoparticles are selected from the group consisting of graphene nanoparticles, graphene platelets, electrically-conductive nanorods, electrically-conductive nanoplatelets graphene oxide, and combinations thereof; wherein the base fluid is selected from the group consisting of a non-aqueous fluid, an aqueous fluid, and combinations thereof.

13. The method of claim 12, adding electrically conductive nanotubes in addition to the nanoparticles to the base fluid.

14. The method of claim 12, wherein the fluid has a resistivity range from about 0.02 ohm-m to about 1,000,000 ohm-m.

15. The method of claim 12, wherein the nanoparticles are present in the fluid in an amount effective to improve the performance of downhole tool as compared to an otherwise identical fluid absent the nanoparticles.

16. The method of claim 12, wherein the nanoparticles have a dimension no greater than 1000 nm.

17. The method of claim 12, wherein the base fluid is selected from the group consisting of a drilling fluid, a completion fluid, a production fluid, and a stimulation fluid.

18. The method of claim 12, wherein the nanoparticles are selected from the group consisting of chemically-modified nanoparticles, covalently-modified nanoparticles, functionalized nanoparticles, physically-modified nanoparticles, electrostatically modified nanoparticles, and combinations thereof; wherein the modification and/or functionalization of the nanoparticles improves their dispersibility in a non-aqueous fluid as compared with otherwise identical nanoparticles which have not been modified or functionalized.

19. The method of claim 12, wherein the nanoparticles are functionalized nanoparticles having at least one functional group selected from the group consisting of a sulfonate, a sulfate, a sulfosuccinate, a thiosulfate, a succinate, a carboxylate, a hydroxyl, a glucoside, a ethoxylate, a propoxylate, a phosphate, an ethoxylate, an ether, an amine, an amide, and combinations thereof.

20. The method of claim 12, wherein the nanoparticles are covalently-modified nanoparticles having at least one covalent modification selected from the group consisting of oxidation; fluorination; free radical additions; addition of carbenes, nitrenes and other radicals; arylamine attachment via diazonium chemistry; and the like; and combinations thereof.

21. The method of claim 13 where the amount of nanoparticles in the fluid range from about 0.0001 wt % to about 15 wt % of the total fluid.

22. A method for modifying the electrical properties of a fluid where the method comprises:
adding nanoparticles to a base fluid where the base fluid is selected from the group consisting of a non-aqueous fluid, an aqueous fluid; and combinations thereof, and where the nanoparticles are selected from the group consisting of graphene nanoparticles, graphene platelets, electrically-conductive nanotubes, electrically-conductive nanorods, electrically-conductive nanoplatelets, and combinations thereof; wherein the nanoparticles are chemically-modified, covalently modified, and combinations thereof;
adding a surfactant in an amount effective to suspend the nanoparticles in the base fluid; and
dispersing the nanoparticles in the base fluid such that the fluid has a resistivity range of from about 0.02 ohm-m to about 1,000,000 ohm-m.
